(19) United States
(12) Patent Application Publication
(10) Pub. No.: US 2007/0115515 A1
(43) Pub. Date: May 24, 2007

(54) Buffer devices and scanners with buffer capability

(75) Inventor: Tsung Te Lin, Taipei (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/557,192

(22) Filed: Nov. 7, 2006

(30) Foreign Application Priority Data
Nov. 8, 2005 (TW) TW94139115

(51) Int. Cl. H04N 1/04

(52) U.S. Cl. 358/497

(57) ABSTRACT

A Buffer devices and scanners with buffer capability are provided. A buffer device includes a body, a movable component, and an elastic structure. The body includes a groove. The movable component is slidingly disposed in the groove. The elastic structure is connected between the body and the movable component.

### BACKGROUND OF THE INVENTION

1. Field of the Invention

The invention relates to buffer devices and scanners with buffer capability.

2. Description of the Related Art

Conventionally, in a contact image sensor (CIS) scanner, a spacer is disposed on a scan module to separate a transparent plate from the scan module by a preferred distance.

When the scan module initializes, the scan module and the spacer may vibrate due to instantaneous momentum, thus degrading scan quality.

### BRIEF SUMMARY OF INVENTION

A Buffer devices and scanners with buffer capability are provided.

An exemplary embodiment of a buffer device includes a body, a movable component, and an elastic structure. The body includes a groove. The movable component is slidingly disposed in the groove. The elastic structure is connected between the body and the movable component.

An embodiment of a scanner with buffer capability includes a housing, a scan module, and a buffer device. The housing includes a transparent plate bearing a scan target. The scan module is movably disposed in the housing to scan the scan target through the transparent plate. The buffer device includes a body, a movable component, and an elastic structure. The body is disposed on the scan module and includes a groove. The movable component is slidingly disposed in the groove and substantially contacts the transparent plate. The elastic structure is connected between the body and the movable component.

### BRIEF DESCRIPTION OF DRAWINGS

The invention can be more fully understood by reading the subsequent detailed description and examples with references made to the accompanying drawings, wherein:

FIG. 1 is a diagram of an embodiment of a scanner with buffer capability;

FIG. 2a is a diagram of a buffer device in FIG. 1;

FIG. 2b is an exploded view of a buffer device in FIG. 2a;

FIG. 2c is a sectional view of a buffer device in FIG. 2a;

FIG. 2d shows that an elastic rib is deformed when a scan module moves to make a body and a movable component move;

FIG. 3 is a diagram of another embodiment of a scanner with buffer capability;

FIG. 4a is a diagram of a buffer device in FIG. 3; and

FIG. 4b is an exploded view of a buffer device in FIG. 4a; and

FIG. 4c shows the body moves along an arrow A.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

A principle aim of the invention is to add a buffer device in a scanner to absorb instantaneous momentum generated when a scan module initializes, thus improving scan quality.

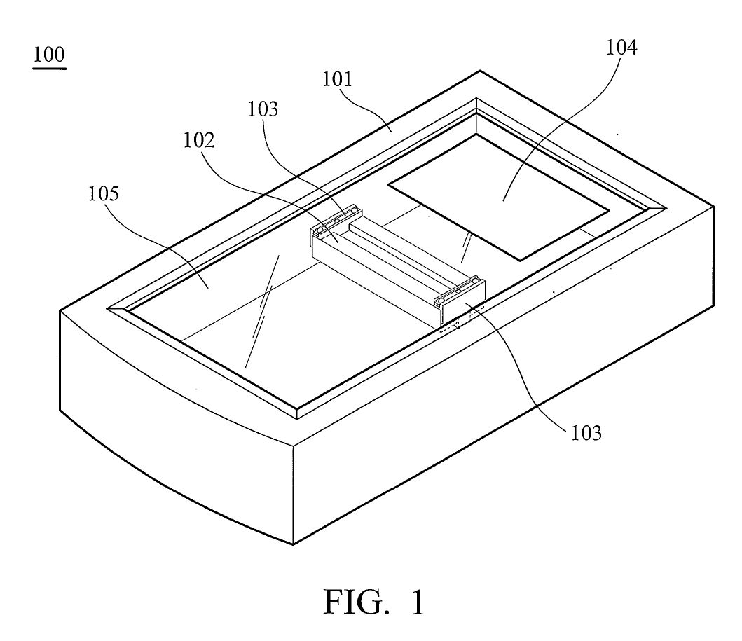

FIG. 1 is a diagram of an embodiment of a scanner 100 with buffer capability.

As shown, the scanner 100 includes a housing 101, a scan module 102, and two buffer devices 103.

The housing 101 includes a transparent plate 105 bearing a scan target 104.

The scan module 102 is movably disposed in the housing 101 to scan the scan target 104 through the transparent plate 105.

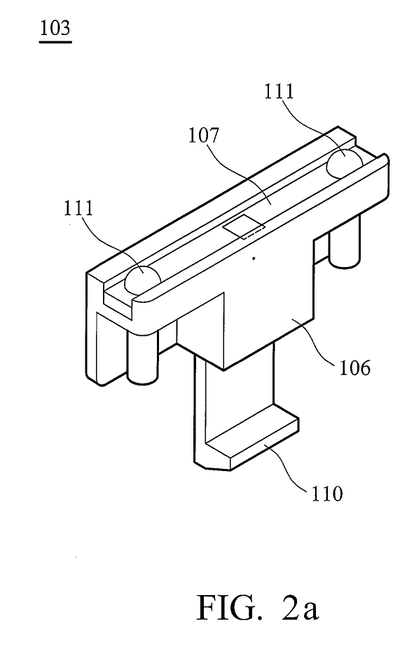

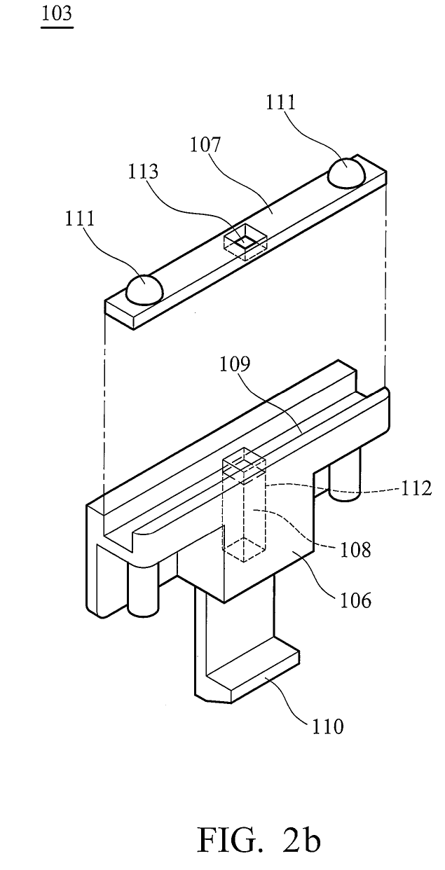

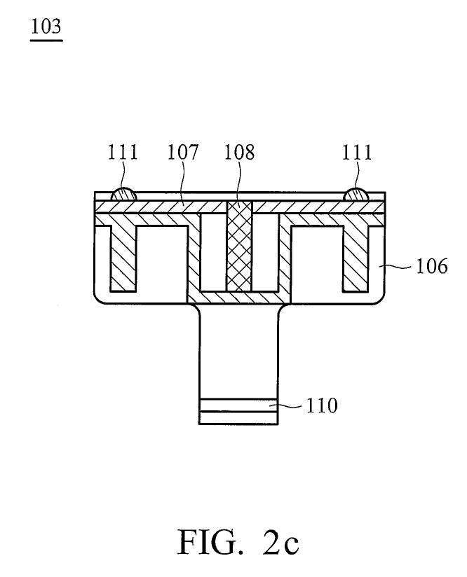

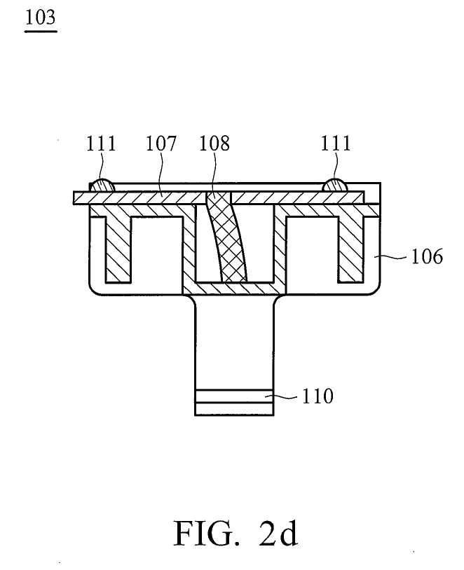

FIG. 2a is a diagram of a buffer device 103 in FIG. 1. FIG. 2b is an exploded view of the buffer device 103 in FIG. 2a. FIG. 2c is a sectional view of the buffer device 103 in FIG. 2a.

As shown, the buffer device 103 includes a body 106, a movable component 107, and an elastic structure 108.

The body 106 includes a groove 109, a hook 110 and a hole 112. The body 106 engages with the scan module 102 by the hook 110 (shown in FIG. 1).

The movable component 107 is slidingly disposed in the groove 109. The movable component 107 includes two spacer portions 111 and an opening 113. The spacer portions 111 substantially contact the transparent plate 105 to separate the transparent plate 105 from the scan module 102 by a preset distance (shown in FIG. 1).

The spacer portions 111 are smooth and wearproof salients.

The elastic structure 108 is an elastic rib connected between the body 106 and the movable component 107, absorbing instantaneous momentum generated when the scan module 102 initializes. In detail, one end of the elastic rib is engaged in the hole 106 of the body 112, and the other end is engaged in the opening 113 of the movable component 107. FIG. 2d shows that the elastic rib is deformed when the scan module 102 moves to make the body 106 and the movable component 107 move.

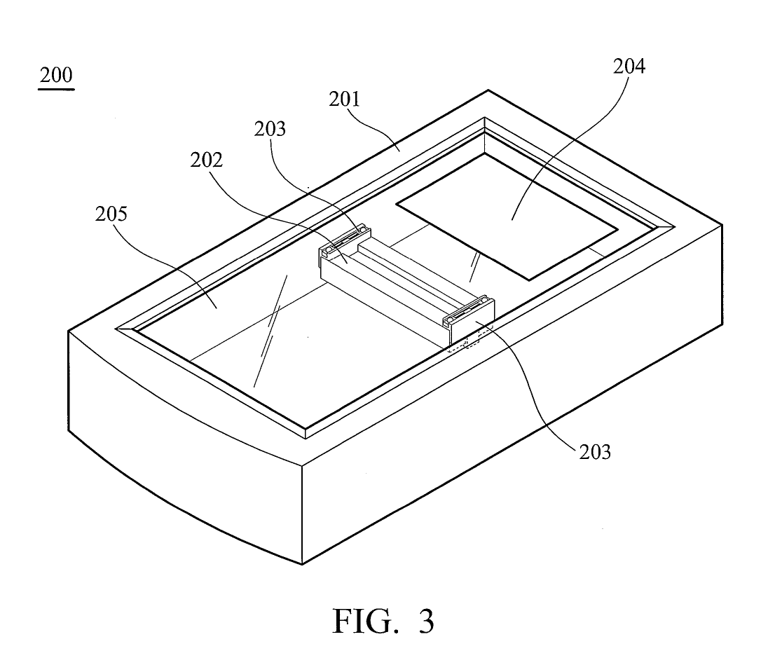

FIG. 3 is a diagram of another embodiment of a scanner 200 with buffer capability.

As shown, the scanner 200 includes a housing 201, a scan module 202, and two buffer devices 203.

The housing 201 includes a transparent plate 205 bearing a scan target 204.

The scan module 202 is movably disposed in the housing 201 to scan the scan target 204 through the transparent plate 205.

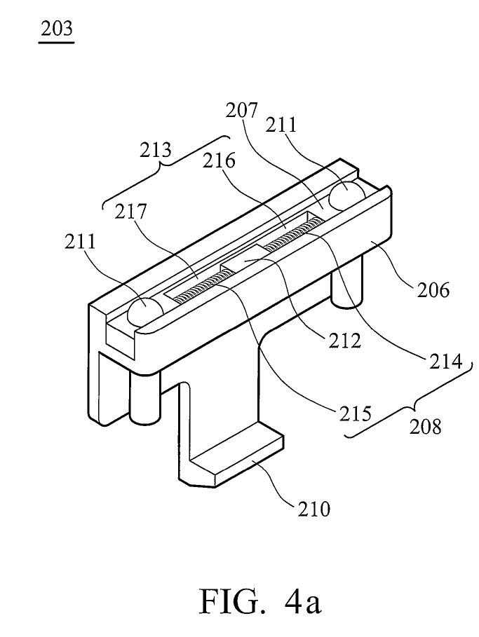

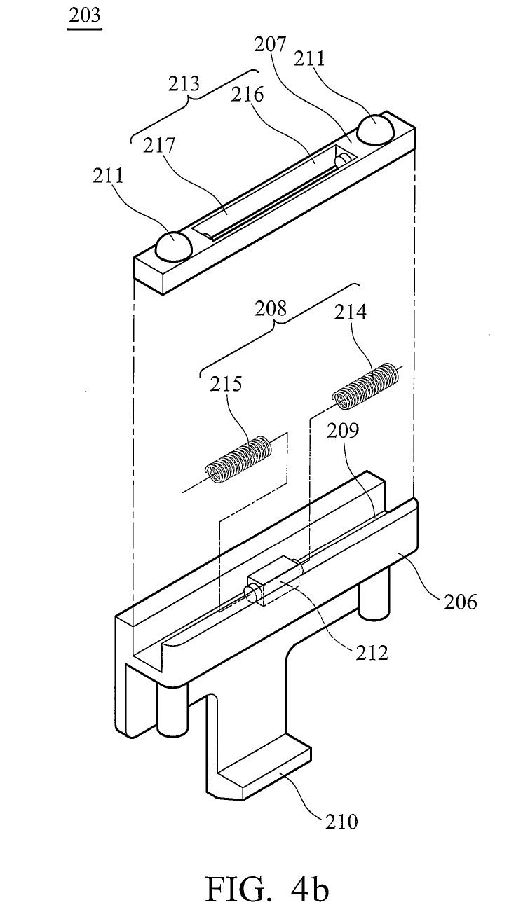

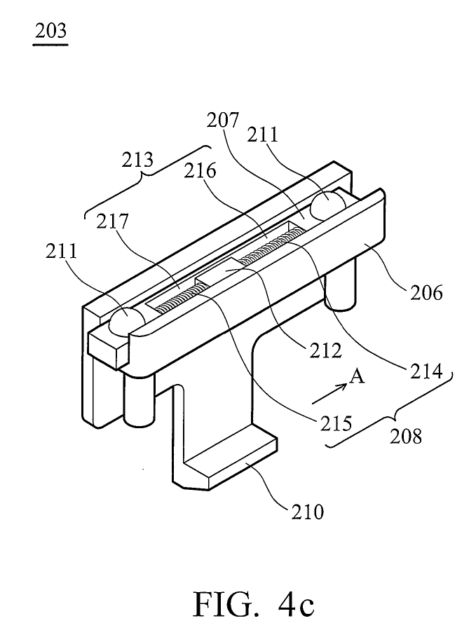

FIG. 4a is a diagram of a buffer device 203 in FIG. 3. FIG. 4b is an exploded view of the buffer device 203 in FIG. 4a.

As shown, the buffer device 203 includes a body 206, a movable component 207, and an elastic structure 208.

The body 206 includes a groove 209, a stopper 212, and a hook 210. The body 206 engages with the scan module 202 by the hook 210 (shown in FIG. 3).

The stopper 212 is disposed in the groove 209. The movable component 207 includes an opening 213. The elastic structure 208 includes a first spring 214 and a second spring 215, absorbing instantaneous momentum generated when the scan module 202 initializes.

The first spring 214 and the second spring 215 are compression springs.

The movable component 207 is slidingly disposed in the groove 209. The stopper 212 is in the opening 213 such that the opening 213 forms a first space 216 and a second space 217. Additionally, the first spring 214 is disposed in the first space 216, and the second spring 215 is disposed in tie second space 217. The first spring 214 and second spring 215 are respectively installed on two ends of the stopper 212. The first spring 214 connects to the stopper 212 and the spacer portions 211. The second spring 215 connects to the stopper 212 and the spacer portions 211. When the movable component 207 slides along an arrow A on the body 206, the first spring 214 and second spring 215 absorb instantaneous momentum (shown by FIG. 4c).

Moreover, the longitudinal direction of the first spring 214, the longitudinal direction of the second spring 215, and the moving direction of the scan module 202 are virtually the same (shown in FIG. 3).

The movable component 207 further includes two spacer portions 21 1. The spacer portions 211 substantially contact the transparent plate 205, separating the transparent plate 205 from the scan module 202 by a preset distance (shown in FIG. 3).

The spacer portions 211 are smooth and wearproof salients.

The scanner of the invention utilizes a buffer device disposed on a scan module to absorb instantaneous momentum generated when the scan module initializes, thus avoiding vibration of the scan module and improving scan quality.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A buffer device, comprising:
a body, comprising a groove;
a movable component, slidingly disposed in the groove; and
an elastic structure, connected between the body and the movable component.

2. The buffer device as claimed in claim 1, wherein the body further comprises a hook.

3. The buffer device as claimed in claim 1, wherein the movable component comprises a salient.

4. The buffer device as claimed in claim 1, wherein the elastic structure is an elastic rib.

5. The buffer device as claimed in claim 4, wherein the body comprises a hole for receiving the elastic rib, at least one end of the elastic rib being fixed in the hole.

6. The buffer device as claimed in claim 4, wherein the movable component comprises an opening and the elastic rib connects thereto.

7. The buffer device as claimed in claim 1, wherein the body further comprises a stopper, disposed in the groove, the movable component further comprises an opening, and the elastic structure comprises a first spring and a second spring, wherein when the movable component is disposed in the groove, the stopper is in the opening such that the opening forms a first space and a second space, wherein the first spring is disposed in the first space, and the second spring is disposed in the second space.

8. The buffer device as claimed in claim 5, wherein the first and the second springs are compression springs.

9. A scanner with buffer capability, comprising:
a housing, comprising a transparent plate for bearing a scan target;
a scan module, movably disposed in the housing for scanning the scan target
through the transparent plate; and
a buffer device, comprising:
a body, disposed on the scan module, the body comprising a groove;
a movable component, slidably disposed in the groove, substantially contacting the transparent plate; and
an elastic structure, connected between the body and the movable component.

10. The scanner as claimed in claim 9, wherein the body further comprises a hook, and the body engages with the scan module by the hook.

11. The scanner as claimed in claim 9, wherein the movable component further comprises a spacer portion, and the spacer portion substantially contacts the transparent plate to separate the transparent plate from the scan module by a preset distance.

12. The scanner as claimed in claim 11, wherein the spacer portion is smooth and wearproof.

13. The scanner as claimed in claim 11, wherein the spacer portion is a salient.

14. The scanner as claimed in claim 9, wherein the elastic structure is an elastic rib.

15. The scanner as claimed in claim 9, wherein the body further comprises a stopper disposed in the groove, the movable component further comprises an opening, and the elastic structure comprises a first spring and a second spring, wherein when the movable component is disposed in the groove, the stopper is in the opening such that the opening forms a first space and a second space, wherein the first spring is disposed in the first space, and the second spring is disposed in the second space.

16. The scanner as claimed in claim 15, wherein when the first spring is disposed in the first space, the longitudinal direction of the first spring, the longitudinal direction of the second spring, and the moving direction of the scan module are virtually the same.

17. The scanner as claimed in claim 15, wherein the first and the second springs are compression springs.
